(19) United States
(12) Patent Application Publication
(10) Pub. No.: US 2006/0291358 A1
(43) Pub. Date: Dec. 28, 2006

(54) Optical disk medium recording and reproducing apparatus and method for discriminating optical disk medium type

(75) Inventor: Yoshiyuki Hiranabe, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/474,405

(22) Filed: Jun. 26, 2006

(30) Foreign Application Priority Data
Jun. 28, 2005 (JP) 2005-187761

(51) Int. Cl. G11B 7/00

(52) U.S. Cl. 369/53.22

(57) ABSTRACT

The invention provides an optical disk medium reproducing apparatus, having shortened the processing time for re-discriminating (estimating) the optical disk medium type when the discrimination of the optical disk medium type fails. In discriminating two types of optical disk media in which a distance from the disk surface to the recording layer of one medium is a first distance (CD-based medium, 1.2 mm) and a distance of the other medium is a second distance (DVD-based medium, 0.6 mm), a predetermined range in which erroneous discrimination of the two types of optical disk media is likely to occur is determined by setting “point B” and “point C” between said first and second distances, and when the distance falls within said range, a “reflectivity information of the recording layer” is prioritized over a “distance information of the recording layer” in estimating the optical disk medium type, by which the processing time is shortened.

The present application is based on and claims priority of Japanese patent application No. 2005-187761 filed on Jun. 28, 2005, the entire contents of which are hereby incorporated by reference.

### BACKGROUND OF THE INVENTION

1. Field of the Invention

The present invention relates to an optical disk medium recording and reproducing apparatus capable of reproducing and/or recording data on multiple types of optical disk media having various distances from the disk surface to the recording layer and various reflectivities to laser beams, and more specifically, relates to a method for discriminating the optical disk medium type.

2. Description of the Related Art

Optical disk media such as CDs and DVDs are used widely since they can be handled easily and are randomly accessible, and there are various types or standards of optical disk media. For example, CD-R and CD-RW are examples of CD-based media, DVD-R, DVD-RW and a double-recording-layer DVD having two recording layers are examples of DVD-based media, and there are various other media.

Apparatuses for reproducing and/or recording data on optical disk media include a multiple-type recording and reproducing apparatus capable of reproducing and/or recording data on multiple types of media mentioned above, but if the type or standard of the optical disk media differ, the physical structures and format methods thereof also differ, so it becomes necessary for the multiple-type recording and reproducing apparatus to discriminate the optical disk medium type at first as a premise before performing recording and reproducing operation to the optical disk medium. The prior art related to discriminating the optical disk medium type are disclosed for example in Japanese Patent Application Laid-Open Publications No. 10-134496 (patent document 1), No. 10-134497 (patent document 2), No. 11-7710 (patent document 3), No. 2003-22536 (patent document 4), No. 2004-206765 (patent document 5), No. 2005-56543 (patent document 6) and No. 2005-85351 (patent document 7).

One prior art method for discriminating the optical disk medium type utilizes the fact that the distances from the disk surfaces to the recording layers differ among some types of media, such as approximately 1.2 mm in CD-based disks and approximately 0.6 mm in DVD-based disks, and that the reflectivity to laser beams differ among some types of media, such as in a pit-type media including CD-ROM and DVD-ROM and in a phase change-type media including CD-RW and DVD-RW, and therefore, it measures both the distance from the disk surface to the recording layer and the reflectivity in order to discriminate the optical disk medium type based on the measured information.

According to the above method, if all the optical disk media being the object of discrimination corresponds to the respective standards of the media types, the discrimination process can be performed well. However, under present circumstances, media that are not up to standard or off the specification from the standard are available in the market. Moreover, even if a disk medium is up to standard when it is manufactured, it may be damaged during use and fall below standard. Such optical disk media falling below standard may not be correctly discriminated, and if a calibration process, which is a process for setting up various parameters according to the medium type such as for adjusting laser output or amplitude of signals obtained from reflected light, is performed based on the erroneous medium type, the process may fail. What is meant by the calibration process failing is that, for example, an expected signal could not be obtained when a specific operation based on the calibration process is performed. In the prior art, in order to cope with this problem, a retry order is defined for each medium type in case the discrimination of the optical disk medium fails, or the calibration process fails, one example of which is shown in FIG. 18 showing a table of the retry order when the discrimination of the optical disk medium type fails, and the calibration process is set to be repeated by changing the disk type based on the retry order.

However, since according to the present method, the disk types are switched in a uniform order for performing the calibration process, so that if the medium is actually the optical disk medium assigned to a latter part of the order, the process took up too much time.

### SUMMARY OF THE INVENTION

In consideration of the problems mentioned above, the present invention aims at providing an optical disk medium recording and reproducing apparatus capable of performing reproducing and/or recording operation to multiple types of optical disk media, which is capable of reducing the processing time for re-discriminating or estimating the optical disk medium type when the discrimination of the optical disk medium type fails.

The optical disk medium recording and reproducing apparatus according to aspect 1 of the present invention is an optical disk medium recording and reproducing apparatus capable of performing recording or reproducing operation to multiple types of optical disk media having various distances from a disk surface to a recording layer and various reflectivities to laser beams, the apparatus comprising: a light source unit for irradiating a laser beam to the optical disk medium; a reflectivity measurement unit for acquiring information on the reflectivity of the optical disk medium with respect to the laser beam output from the light source unit; a recording layer depth measurement unit for acquiring information on the distance from the disk surface to the recording layer; and a storage unit for storing a predetermined range between a first distance and a second distance, one of two types of optical disk media selected from the multiple types of optical disk media having the first distance from the disk surface to the recording layer and the other one having the second distance from the disk surface to the recording layer; wherein after discriminating the optical disk medium type based on the distance information from the disk surface to the recording layer acquired by the recording layer depth measurement unit and the reflectivity information of the optical disk medium acquired by the reflectivity measurement unit, if it is determined that the discrimination of the optical disk medium type has failed and if the distance information from the disk surface to the recording layer acquired by the recording layer depth measurement unit corresponds to the predetermined range, the information of the reflectivity acquired by the reflectivity measurement unit is prioritized in estimating the optical disk medium type, whereas if it is determined that the discrimination of the optical disk medium type has failed and if the distance information from the disk surface to the recording layer acquired by the recording layer depth measurement unit does not correspond to the predetermined range, the distance information from the disk surface to the recording layer is prioritized in estimating the optical disk medium type.

According to the above arrangement, if the distance from the disk surface to the recording layer corresponds to “a predetermined range between a first distance and a second distance, one optical disk medium having the first distance from the disk surface to the recording layer and the other one having the second distance from the disk surface to the recording layer”, in other words, if the reliability of discrimination whether the distance is a “first distance” or a “second distance” is low and erroneous discrimination is likely to occur, and if it is “determined that the discrimination of the optical disk medium type has failed”, the “reflectivity information of the disk” is prioritized over the “distance information from the disk surface to the recording layer” in estimating the optical disk medium type. On the other hand, if the distance does not correspond to “a predetermined range between a first distance and a second distance”, in other words, if the reliability of discrimination whether the distance is a “first distance” or a “second distance” is high and erroneous discrimination is not likely to occur, and if it is “determined that the discrimination of the optical disk medium type has failed”, the “distance information from the disk surface to the recording layer” is prioritized in estimating the optical disk medium type. Now, what is meant by “a predetermined range between a first distance and a second distance, one of two types of optical disk media selected from the multiple types of optical disk media having the first distance from the disk surface to the recording layer and the other one having the second distance from the disk surface to the recording layer” is that there are not only two media that have different distances from the disk surface to the recording layer, but that the relationship between two adjacent optical disk media arbitrarily selected from a list of multiple media having different distances from the disk surface to the recording layer listed in the order of distance is referred to.

The optical disk medium recording and reproducing apparatus according to aspect 2 of the present invention is an optical disk medium recording and reproducing apparatus capable of performing recording or reproducing operation to multiple types of optical disk media having various distances from a disk surface to a recording layer and various reflectivities to laser beams, the apparatus comprising: a light source unit for irradiating a laser beam to the optical disk medium; a reflectivity measurement unit for acquiring information on the reflectivity of the optical disk medium with respect to the laser beam output from the light source unit; a recording layer depth measurement unit for acquiring information on the distance from the disk surface to the recording layer; and a storage unit for storing a predetermined range between a first reflectivity and a second reflectivity, one of two types of optical disk media selected from the multiple types of optical disk media having the first reflectivity to the laser beam and the other one having the second reflectivity to the laser beam; wherein after discriminating the optical disk medium type based on the distance information from the disk surface to the recording layer acquired by the recording layer depth measurement unit and the reflectivity information of the optical disk medium acquired by the reflectivity measurement unit, if it is determined that the discrimination of the optical disk medium type has failed, wherein if the reflectivity information of the optical disk medium acquired by the reflectivity measurement unit corresponds to the predetermined range, the distance information from the disk surface to the recording layer acquired by the recording layer depth measurement unit is prioritized in estimating the optical disk medium type, whereas if the reflectivity information of the optical disk medium acquired by the reflectivity measurement unit does not correspond to the predetermined range, the reflectivity information is prioritized in estimating the optical disk medium type.

According to the above arrangement, if the reflectivity of the disk corresponds to “a predetermined range between a first reflectivity and a second reflectivity, one of two types of optical disk media selected from the multiple types of optical disk media having the first reflectivity to the laser beam and the other one having the second reflectivity to the laser beam”, in other words, if the reliability of discrimination on whether the reflectivity is a “first reflectivity” or a “second reflectivity” is low and erroneous discrimination is likely to occur, and if it is “determined that the discrimination of the optical disk medium type has failed”, the “distance information from the disk surface to the recording layer” is prioritized over the “reflectivity information of the disk” in estimating the optical disk medium type. On the other hand, if the reflectivity of the disk does not correspond to “a predetermined range between a first reflectivity and a second reflectivity”, in other words, if the reliability of discrimination on whether the reflectivity is a “first reflectivity” or a “second reflectivity” is high and erroneous discrimination is not likely to occur, and if it is “determined that the discrimination of the optical disk medium type has failed”, the “reflectivity information of the disk” is prioritized in estimating the optical disk medium type. Now, what is meant by “a predetermined range between a first reflectivity and a second reflectivity, one of two types of optical disk media selected from the multiple types of optical disk media having the first reflectivity to the laser beam and the other one having the second reflectivity to the laser beam” is that there are not only two media that have different reflectivity, but that the relationship between two adjacent optical disk media arbitrarily selected from a list of multiple media having different reflectivity listed in the order of reflectivity is referred to.

The optical disk medium recording and reproducing apparatus according to aspect 3 of the present invention is an optical disk medium recording and reproducing apparatus according to aspects 1 or 2, wherein upon estimating the optical disk medium type prioritizing the reflectivity information, the estimation of the optical disk medium type is performed using the distance information from the disk surface to the recording layer acquired by the recording layer depth measurement unit as the secondary determination factor, whereas upon estimating the optical disk medium type prioritizing the information of the distance from the disk surface to the recording layer, the estimation of the optical disk medium type is performed using the reflectivity information acquired by the reflectivity measurement unit as the secondary determination factor.

According to the above arrangement, the estimation of the optical disk medium type is performed using both the “distance information from the disk surface to the recording layer” and the “reflectivity information of the disk” after determining which information is to be prioritized.

The optical disk medium recording and reproducing apparatus according to aspect 4 of the present invention is an optical disk medium recording and reproducing apparatus according to any one of aspects 1 through 3, wherein upon performing a calibration process which is a correction process of various parameters corresponding to the optical disk medium type discriminated or estimated based on the discrimination process or the estimation process of the optical disk medium type, if the calibration process fails, the apparatus determines that the discrimination or estimation of the optical disk medium type has failed, and if it is determined that the discrimination or estimation has failed, the estimation or re-estimation of the optical disk medium type is performed, and based on the optical disk medium type estimated thereby, a retry of the calibration process is performed based on the estimated optical disk medium type.

According to the above arrangement, it is determined that the “discrimination of the optical disk medium type has failed” based on the failure of the calibration process, and a retry of the calibration process is performed based on the optical disk medium type obtained through estimation or re-estimation of the optical disk medium type.

The optical disk medium recording and reproducing apparatus according to aspect 5 of the present invention is an optical disk medium recording and reproducing apparatus according to aspect 4, wherein the storage unit stores tables storing information on the order of optical disk medium types for performing retry of the calibration process when the primary discrimination has failed for each type of optical disk medium determined primarily by the discrimination process, the tables including a distance information priority table using the distance information from the disk surface to the recording layer corresponding to the primarily determined optical disk medium type as the primary factor and the reflectivity information thereof as the secondary factor upon applying order information to the optical disk medium type, and a reflectivity information priority table using the reflectivity information corresponding to the primarily determined optical disk medium type as the primary factor and the distance information from the disk surface to the recording layer thereof as the secondary factor upon applying order information to the optical disk medium type; wherein upon performing retry of the calibration process, if the distance information from the disk surface to the recording layer is prioritized in estimating the optical disk medium type, the estimation is performed by referring to the distance information priority table, whereas if the reflectivity information is prioritized in estimating the optical disk medium type, the estimation is performed by referring to the reflectivity information priority table.

According to the above arrangement, the “estimation of the optical disk medium type prioritizing the distance information from the disk surface to the recording layer” is performed by changing the disk types according to the order stored in the distance information priority table, and the “estimation of the optical disk medium type prioritizing the reflectivity information” is performed by changing the disk types according to the order stored in the reflectivity information priority table.

A method for discriminating optical disk medium type according to aspect 6 of the present invention is a method for discriminating optical disk medium type of an optical disk medium recording and reproducing apparatus capable of performing recording or reproducing operation to multiple types of optical disk media having various distances from a disk surface to a recording layer and various reflectivities to laser beams, the method comprising: determining in advance a predetermined range between a first distance and a second distance, one of two types of optical disk media selected from the multiple types of optical disk media having the first distance from the disk surface to the recording layer and the other one having the second distance from the disk surface to the recording layer; wherein after discriminating the optical disk medium type based on the distance information from the disk surface to the recording layer and the reflectivity information of the optical disk medium, if it is determined that the discrimination of the optical disk medium type has failed and if the distance information from the disk surface to the recording layer corresponds to the predetermined range, the information of the reflectivity is prioritized in estimating the optical disk medium type, whereas if it is determined that the discrimination of the optical disk medium type has failed and if the distance information from the disk surface to the recording layer does not correspond to the predetermined range, the distance information from the disk surface to the recording layer is prioritized in estimating the optical disk medium type.

A method for discriminating optical disk medium type according to aspect 7 of the present invention is a method for discriminating optical disk medium type of an optical disk medium recording and reproducing apparatus capable of performing recording or reproducing operation to multiple types of optical disk media having various distances from a disk surface to a recording layer and various reflectivities to laser beams, the method comprising: determining in advance a predetermined range between a first reflectivity and a second reflectivity, one of two types of optical disk media selected from the multiple types of optical disk media having the first reflectivity and the other one having the second reflectivity; wherein after discriminating the optical disk medium type based on the distance information from the disk surface to the recording layer and the reflectivity information of the optical disk medium, if it is determined that the discrimination of the optical disk medium type has failed, wherein if the reflectivity information of the optical disk medium corresponds to the predetermined range, the distance information from the disk surface to the recording layer is prioritized in estimating the optical disk medium type, whereas if the reflectivity information of the optical disk medium does not correspond to the predetermined range, the reflectivity information is prioritized in estimating the optical disk medium type.

Moreover, the method for discriminating optical disk medium type according to the present invention is a method for discriminating optical disk medium type according to aspects 6 or 7 of the invention, wherein upon estimating the optical disk medium type prioritizing the reflectivity information, the distance information from the disk surface to the recording layer is used as a secondary determination factor in estimating the optical disk medium type, whereas upon estimating the optical disk medium type prioritizing in the distance information from the disk surface to the recording layer, the reflectivity information is used as a secondary determination factor in estimating the optical disk medium type.

Further, the method for discriminating optical disk medium type according to the present invention is a method for discriminating optical disk medium type according to any one of aspects 6 through 8, wherein upon performing calibration which is a correction process of various parameters corresponding to the optical disk medium type discriminated or estimated based on the discrimination process or the estimation process of the optical disk medium type, if the calibration process fails, the apparatus determines that the discrimination or estimation of the optical disk medium type has failed, and if it is determined that the discrimination or estimation has failed, the estimation or re-estimation of the optical disk medium type is performed, and based on the optical disk medium type estimated thereby, a retry of the calibration process is performed based on the estimated optical disk medium type.

### BRIEF DESCRIPTION OF THE DRAWINGS

FIG. 1 is a block diagram of an optical disk medium recording and reproducing apparatus mainly showing the portion related to the present invention;

FIG. 2 is a block diagram showing the outline of the pickup portion;

FIG. 3 is a view showing an example of tables stored in the optical disk medium recording and reproducing apparatus;

FIG. 4 is a concept view showing the method for discriminating the optical disk medium type and the relationship between tables used for estimating the medium type when the discrimination fails;

FIG. 5 is a view showing an example of the waveforms of a focus error signal and a PI signal;

FIG. 6 is a flowchart showing the outline of a disk medium type discrimination process according to the optical disk medium recording and reproducing apparatus 1;

FIG. 7 is a flowchart showing the outline of the disk medium type estimation process according to the optical disk medium recording and reproducing apparatus 1;

FIG. 8 shows an example of tables stored in the optical disk medium recording and reproducing apparatus according to embodiment 2;

FIG. 9 is a concept view showing the method for discriminating the optical disk medium type according to embodiment 2 and the relationship between tables used for estimating the medium type when the discrimination fails;

FIG. 10 is a flowchart showing the outline of a disk medium type discrimination process according to embodiment 2;

FIG. 11 is a flowchart showing the outline of a disk medium type estimation process according to embodiment 2;

FIG. 12 is a flowchart continuing from FIG. 11;

FIG. 13 shows an example of tables stored in the optical disk medium recording and reproducing apparatus according to embodiment 3;

FIG. 14 is a concept view showing the method for discriminating the optical disk medium type according to embodiment 3 and the relationship between tables used for estimating the medium type when the discrimination fails;

FIG. 15 is a flowchart showing the outline of a disk medium type discrimination process according to embodiment 3;

FIG. 16 is a flowchart showing the outline of a disk medium type estimation process according to embodiment 3;

FIG. 17 is a flowchart continuing from FIG. 16; and

FIG. 18 shows an example of a table showing the order of retry when the discrimination of the optical disk medium type fails according to the prior art.

### DETAILED DESCRIPTION OF THE PREFERRED EMBODIMENTS

Now, the actual preferred embodiments of the present invention will be described with reference to the drawings. The embodiments mentioned hereafter are merely examples for realizing the present invention, and are not intended to limit the present invention within the range thereof.

### Embodiment 1

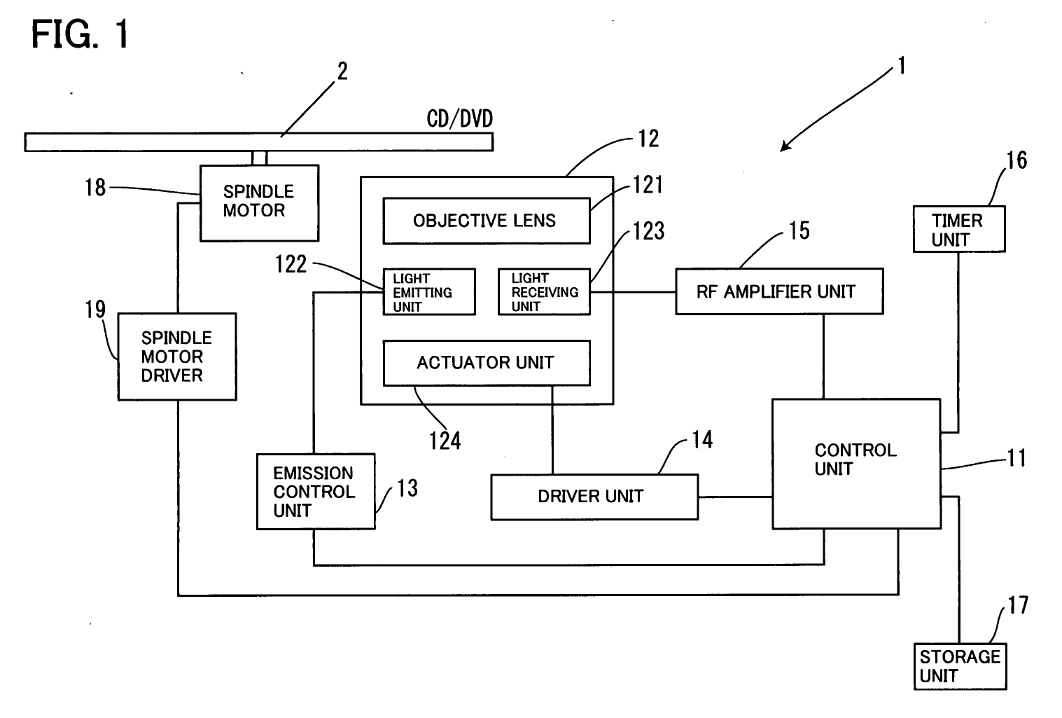

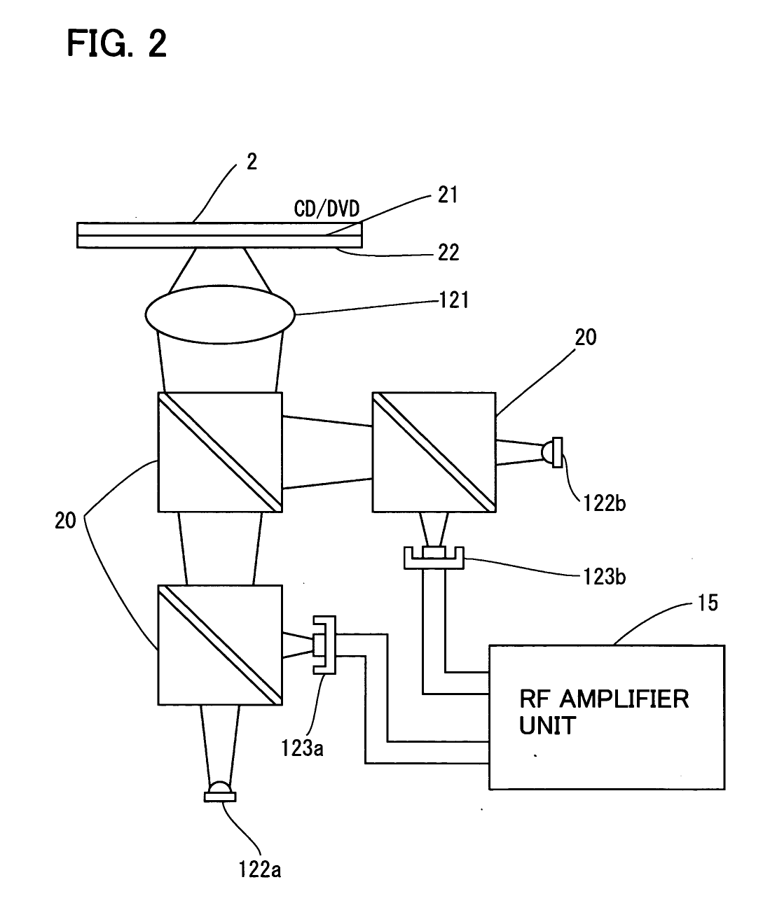

FIG. 1 is a block diagram showing the portion of an optical disk medium reading and reproducing apparatus mainly related to the present invention, and FIG. 2 is a block diagram illustrating the outline of a portion of a pickup unit disposed in the above apparatus.

As illustrated in FIG. 1, the optical disk medium recording and reproducing apparatus 1 of the present embodiment includes a control unit 11 for performing control and other processes of the whole apparatus; a pickup unit 12 equipped with an objective lens 121, a light emitting unit 122 being the light source unit, a light receiving unit 123, an actuator unit 124 and the like; an emission control unit 13 for controlling the light emitting unit 122; a driver unit 14 for controlling the actuator unit 124; an RF amplifier unit 15 for amplifying signals acquired from the light receiving unit 123 and generating focus error signal or PI signal and the like; a timer unit 16 being a timekeeping means; a storage unit 17; a spindle motor 18; a spindle motor driver 19 for controlling the spindle motor 18; and so on.

The optical disk medium recording and reproducing apparatus 1 is an apparatus capable of performing reproducing and/or recording operation for both the CD-based optical disk medium and the DVD-based optical disk medium, wherein the pickup unit 12 comprises, as shown in FIG. 2, a laser diode 122a for emitting laser beams for the CD-based optical disk medium and a photodetector 123a for receiving the light reflected therefrom, a laser diode 122b for emitting laser beams for the DVD-based optical disk medium and a photodetector 123b for receiving the light reflected therefrom, and beam splitters 20. In the present embodiment, a CD-DA (music CD) and a CD-RW are used as examples of the CD-based optical disk media, and a DVD-ROM and a DVD-RW are used as examples of the DVD-based optical disk media.

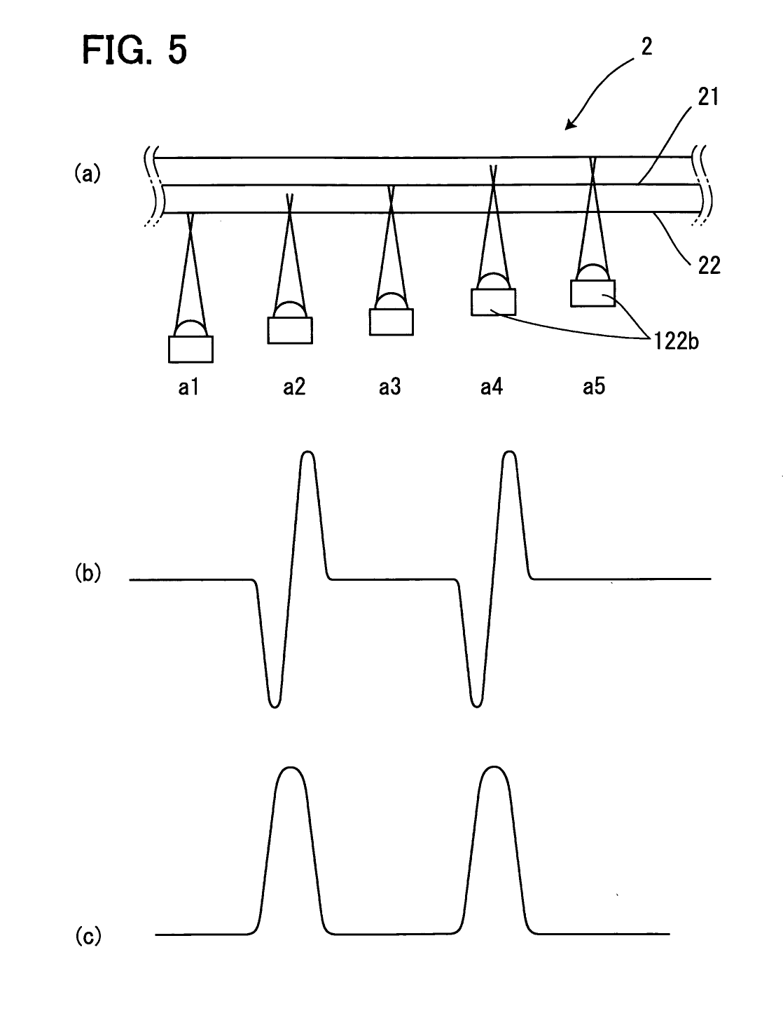

The RF amplifier unit 15 amplifies the signals from the photodetectors 123a and 123b, with the amplification factor changed in response to the type of the optical disk medium 2, and generates a focus error signal, a PI signal and the like. The focus error signal is the differential output of light receiving surfaces in diagonal directions of the photodetector 123b having a quartered light receiving surface, constituting a waveform in which the value is zero when the laser beam is focused on a recording layer 21 (or a disk surface 22) of the optical disk medium 2, with positive and negative peak values appearing before and after zero. FIG. 5(b) shows an example of the waveform. The PI signal is a signal combining the signals obtained from each of the light receiving surfaces of the quartered light receiving surface, wherein the peak value appears at the portion where the focus of the laser beam is on the recording layer 21 (or the disk surface 22) of the optical disk medium 2. FIG. 5(c) shows an example of the waveform. The amplitude of the PI signal is proportional to the reflectivity of the optical disk medium 2.

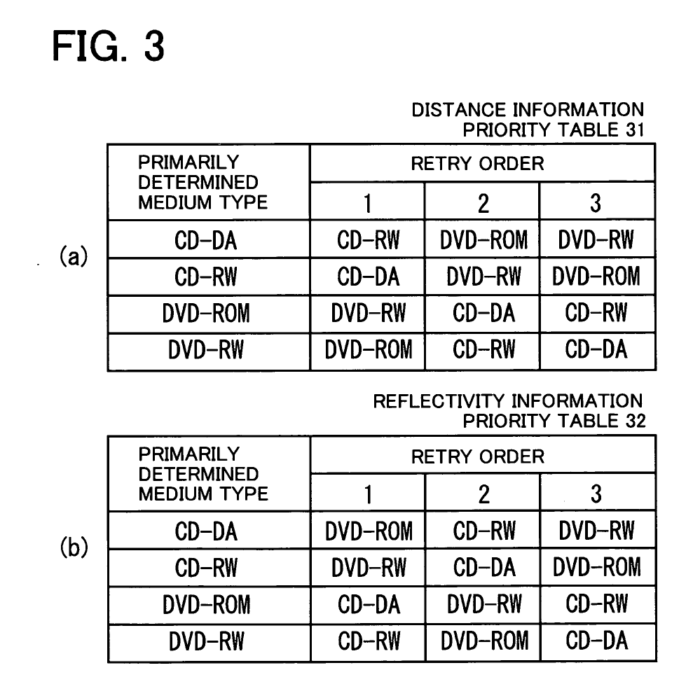

The optical disk medium recording and reproducing apparatus 1 has a distance information priority table 31 (FIG. 3(a)) and a reflectivity information priority table 32 (FIG. 3(b)) stored in the storage unit 17. As shown in FIG. 3, the tables store information on the order of the optical disk media type in retrying a calibration process corresponding to each optical disk medium type determined primarily, if the primary discrimination had failed, that is, if the calibration process using parameters according to the primarily determined optical disk medium type had failed. In other words, the tables are for estimating the optical disk medium type in case the primary discrimination had failed.

The distance information priority table 31 applies the retry order information using the distance information from the disk surface to the recording layer corresponding to the primarily determined optical disk medium type as the primary factor and the reflectivity information as the secondary factor. As an actual example, when it is determined in the primary discrimination that the medium is a CD-based medium in which the distance from the disk surface to the recording layer is long, this information is prioritized and the retry order of the CD-based media is set higher, and secondly, upon determining the retry order of DVD-based media, if it is determined according to the primary discrimination that the medium has a low reflectivity, which means that the medium is a phase change-type media, or CD-RW, this information is used as the secondary factor according to which the retry order of the medium having a lower reflectivity, or DVD-RW, out of the DVD-based media is set higher. On the other hand, the reflectivity information priority table 32 applies the retry order information using the reflectivity information corresponding to the primarily determined optical disk medium type as the primary factor and the distance information from the disk surface to the recording layer as the secondary factor. As an actual example, when it is determined in the primary discrimination that the medium has high reflectivity, in other words, the medium is a pit-type medium, this information is prioritized and the retry order of media having high reflectivity is set higher, and secondly, upon determining the retry order of media having a lower reflectivity, or phase change-type media, if it is determined according to the primary discrimination that the medium is a DVD-based medium in which the distance from the disk surface to the recording layer is short, this information is used as the secondary factor and the retry order of the DVD-based media out of the media having lower reflectivity is set higher.

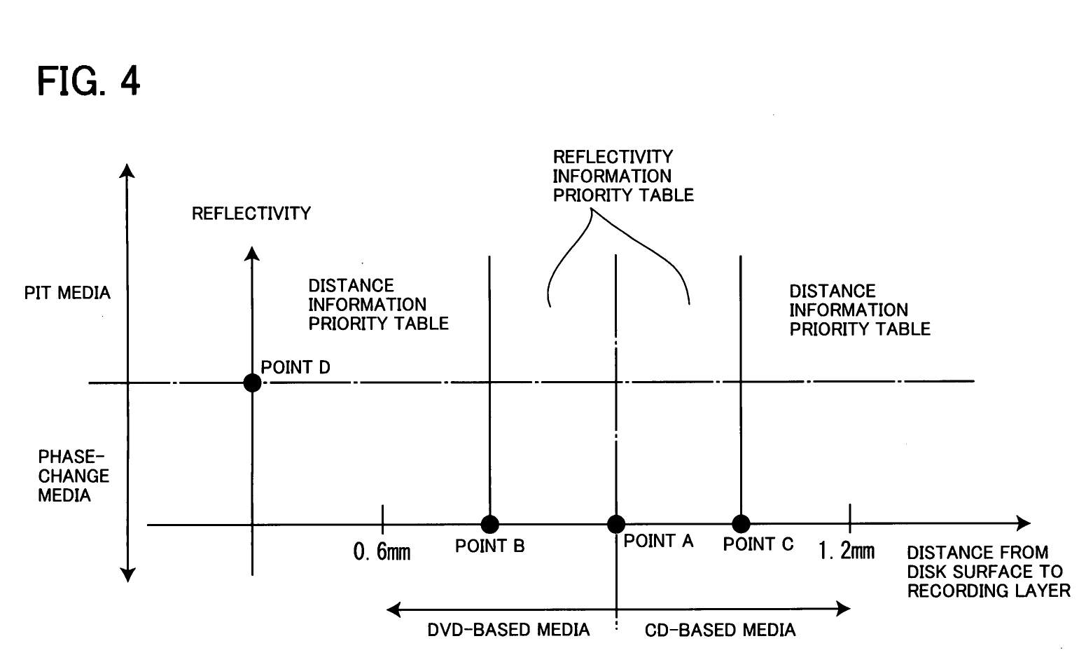

FIG. 4 is a concept view showing the method of discriminating the optical disk medium type, and the relationship between tables used for estimating the medium type if the primary discrimination had failed. The optical disk medium recording and reproducing apparatus 1 according to the present embodiment discriminates the CD-based optical disk media from the DVD-based optical disk media by the differences in distance from the disk surface to the recording layer, wherein the distance of the DVD-based media is approximately 0.6 mm (first distance) and the distance of the CD-based media is approximately 1.2 mm (second distance), and further discriminates whether the media is a pit-type media (CD-DA or DVD-ROM) or phase change-type media (CD-RW or DVD-RW) based on the difference in reflectivity. Based on this process, it is possible to discriminate which of the four types of media the object medium is. In FIG. 4, the horizontal axis represents the “distance from the disk surface to the recording layer” and the vertical axis represents the “reflectivity”. As shown in FIG. 4, whether the medium is a CD-based media or a DVD-based media is discriminated using “point A (for example, 0.9 mm)” as a threshold, and whether the medium is a pit-type media or a phase change-type media is discriminated using “point D” as a threshold. “Point B” and “point C” are values offset for predetermined distances from “point A”, and set so that they exist between the first distance (0.6 mm) and the second distance (1.2 mm). “Point B” and “point C” are for determining the “range in which erroneous discrimination is likely to occur” in discriminating two types of media (CD-based media and DVD-based media), and are determined arbitrarily considering the accuracy of the apparatus and the like. If the distance from the disk surface to the recording layer of the optical disk medium 2 falls within the range between “point B” and “point C”, that is, if erroneous discrimination is likely to occur, the process of estimating the optical disk medium type utilizes the reflectivity information priority table 32, and if not, that is, if erroneous discrimination is not likely to occur, the process utilizes the distance information priority table 31. Moreover, the information denoting “point A”, “point B”, “point C” and “point D” are stored in the storage unit 17 of the optical disk medium recording and reproducing apparatus 1 as variables “a”, “b”, “c” and “d”, respectively. The information denoting “point A”, “point B”, “point C” and “point D” do not store the respective distance or reflectivity numerals directly, but actually, the information related to distance is stored as time information (time required for the objective lens to move toward the focus), and the information related to reflectivity is stored as amplitude information of the PI signal.

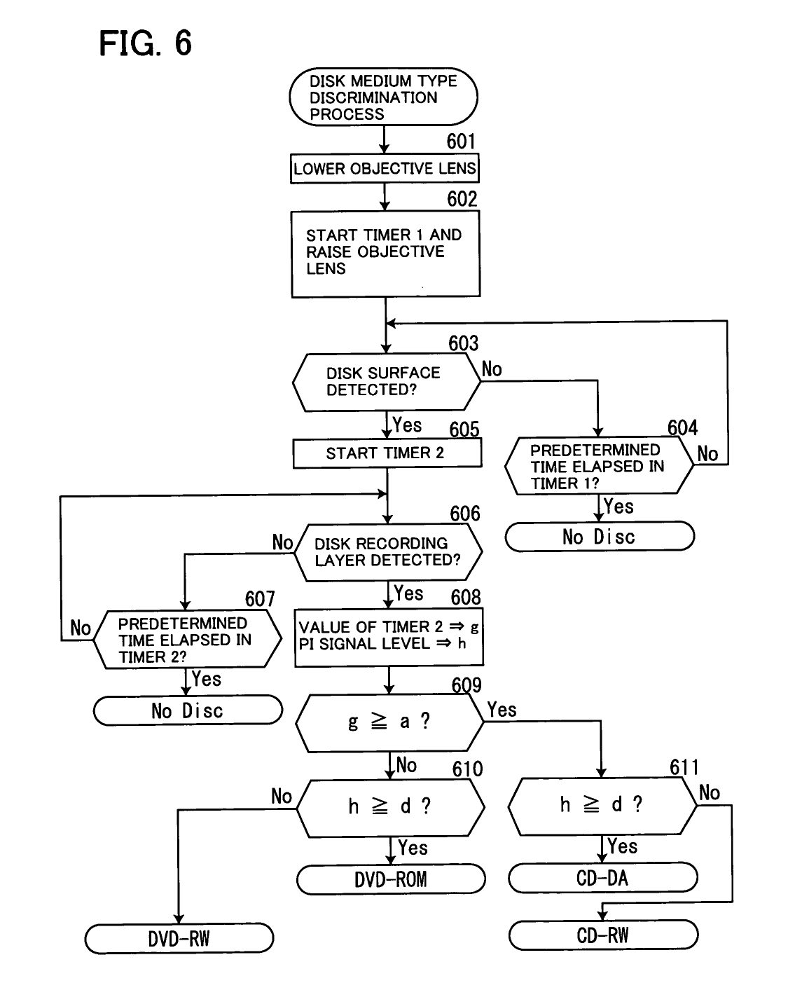

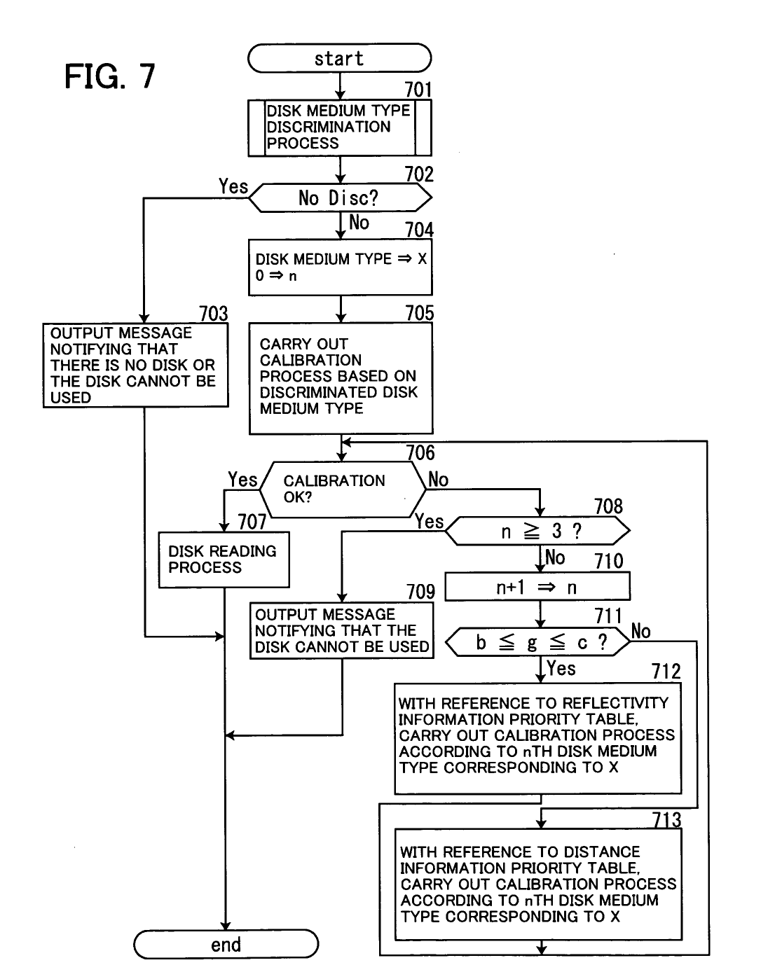

The outline of the discrimination and estimation processes of the type of optical disk medium 2 of the optical disk medium recording and reproducing apparatus 1 having the arrangement described above will be described with reference to FIGS. 6 and 7.

When the optical disk medium 2 is loaded in the optical disk medium recording and reproducing apparatus 1, in order to access the optical disk medium 2, it is necessary to perform a calibration process using parameters corresponding to the type of optical disk medium 2, such as for changing the amplification factor in the aforementioned RF amplifier unit 15 or adjusting output of laser diodes 122a and 122b. Accordingly, at first when the optical disk medium 2 is loaded, it is necessary to discriminate the type of the optical disk medium 2, so the discrimination process is performed in step 701 (FIG. 7).

FIG. 6 is a flowchart showing the outline of the “disk medium type discrimination process”, in other words, the process of step 701 in FIG. 7. In step 601, the objective lens 121 is lowered to position a1 of FIG. 5(a), then timer 1 of the timer unit 16 is started and the objective lens is raised (step 602). Moreover, the objective lens is moved by controlling the actuator unit 124 via the driver unit 14 and the control unit 11.

In step 603, it is discriminated whether the surface of the optical disk medium 2 or disk surface 22 has been detected or not. As mentioned earlier, the present discrimination is performed by discriminating the generation of a peak value via the control unit 11, since a peak value is generated in the focus error signal and the PI signal in the position where the laser is focused on the disk surface 22 (state of a2 of FIG. 5(a)). When the disk surface 22 is not detected in the discrimination process of step 603, whether the timer 1 has elapsed a predetermined time stored in advance in the storage unit 17 or not is discriminated by the control unit 11, and if the time has elapsed, in other words, if the disk surface could not be detected even when the objective lens is raised, a “no disk” state is determined, meaning that the disk could not be detected. If the discrimination in step 604 is negative, the procedure returns to step 603 and the process is repeated.

If the determination in step 603 is positive, that is, if the disk surface 22 had been detected, the timer 2 is started in step 605, and whether the recording layer 21 of the optical disk medium 2 had been detected or not is discriminated in step 606. The present discrimination process is based on a similar concept as step 603. When the recording layer 21 is not detected in the discrimination of step 606, whether or not the timer 2 has elapsed a predetermined time stored in advance in the storage unit 17 is discriminated in step 607, and when the time has elapsed, that is, if the recording layer had not been detected even when the objective lens is raised for a predetermined distance, a “no disk” state is determined, meaning that the disk cannot be used. When the result of the discrimination in step 607 is negative, the process returns to step 606 and the same process is repeated.

When the determination in step 606 is positive (the state shown in a4 of FIG. 5(a) in which the recording layer 21 is detected), the value of timer 2 is assigned to variable g, and the peak value of the amplitude of the PI signal is assigned to variable h in step 608. In the subsequent step 609, it is discriminated whether g is greater than a, that is, whether the medium belongs to the right side of “point A” (CD-based media) or to the left side (DVD-based media) thereof in FIG. 4. If g is smaller than a (DVD-based media), the procedure advances to step 610, where it is discriminated whether h is greater than d or not, in other words, whether the medium belongs to the upper side of “point D” (pit-type media) or the lower side thereof (phase change-type media), and if h is greater than d, the optical disk medium 2 is discriminated as a “DVD-ROM”, and if smaller, it is discriminated as a “DVD-RW”. On the other hand, if it is discriminated in step 609 that g is greater than a (CD-based media), the procedure advances to step 611, where it is discriminated whether h is greater than d or not, that is, whether the medium belongs to the upper side of “point D” in FIG. 4 (pit-type media) or the lower side thereof (phase change-type media), and if h is greater than d, the optical disk medium 2 is discriminated as a “CD-DA”, and if smaller, it is discriminated as a “CD-RW”. As can be recognized from the above-mentioned operation, according to the present embodiment, a “reflectivity measurement unit” is composed of the pickup unit 12, the RF amplifier unit 15 and the control unit 11, and a “recording layer depth measurement unit” is composed of the pickup unit 12, the RF amplifier unit 15, the control unit 11 and the timer unit 16. In the present embodiment, the threshold for discriminating “CD-DA” and “CD-RW” and the threshold for discriminating “DVD-ROM” and “DVD-RW” are the same (threshold d), but the threshold for discriminating them can be different thresholds determined arbitrarily according to the design concept of the apparatus.

The above-mentioned process according to FIG. 6 is performed in step 701 of FIG. 7, and in the subsequent step 702, whether the result of the process of FIG. 6 had been “no disk” or not is discriminated, and if the result had been “no disk”, the procedure advances to step 703 where a message saying that “there is no disk, or the disk cannot be used” (which is output for example to a display unit provided to the apparatus not shown) is output, and the process is ended. If the optical disk medium type 2 had been acquired by the process of FIG. 6, the procedure advances to step 704 where the information denoting the present disk medium type is assigned to X, and 0 is assigned to variable n. Next, in the subsequent step 705, a calibration process is performed using parameters corresponding to the discriminated medium type. If the present calibration process succeeds in step 706, the procedure advances to step 707 where the reading process of the optical disk medium 2 is performed and the process is ended. This merely means that the process for discriminating the disk medium type is ended, and thereafter, the reproducing or recording process of the optical disk medium 2 is performed.

If the determination in step 706 is negative, that is, if the calibration process fails, it is discriminated whether or not n is equal to or greater than 3 in step 708, and if n is smaller than 3, n is incremented in step 710, and whether g is equal to or greater than b and equal to or smaller than c, that is, if it falls between “point B” and “point C” of FIG. 4, is discriminated in step 711. If g, which represents the information on the distance from the disk surface 22 to the recording layer 21 of the optical disk medium 2, correspond to the above, the type of the optical disk medium 2 is estimated based on the reflectivity information priority table 32 (FIG. 3(b)), and if not, it is estimated based on the distance information priority table 31 (FIG. 3(a)), and the calibration process is performed using parameters according to the estimated medium type in step 712 or step 713. After step 712 or step 713, the procedure returns to step 706 and the process is repeated. If the determination in step 708 is positive, that is, if n is equal to or greater than 3, it means that the estimation process of the type of optical disk medium 2 has already been performed three times, which means that the calibration process has failed even after using parameters for all the medium types, so the message notifying that “this disk medium cannot be used (this disk medium is not accommodated in the present apparatus)” is output in step 709, and the process is ended.

As described, according to the optical disk medium recording and reproducing apparatus 1 of the present embodiment, when it is determined that the reliability of discrimination between the “CD-based media” and the “DVD-based media” is low, that is, if the measured distance information is close to the intermediate value between the distance information of the two media, or between point B and point C of FIG. 4, the optical disk medium type is estimated prioritizing the “reflectivity information of the disk” over the “distance information from the disk surface to the recording layer”, and on the other hand, if the reliability of discrimination between the “CD-based media” and the “DVD-based media” is high, the “distance information from the disk surface to the recording layer” is prioritized in estimating the optical disk medium type, according to which the efficiency of the process for estimating the disk type is improved. In other words, if the correct optical disk medium type could not be obtained based on the primary discrimination of the optical disk medium type, the priority of the information likely to cause erroneous discrimination is lowered and the priority of the information not likely to cause erroneous discrimination is raised in estimating the disk medium type, so the possibility that the correct optical disk medium type is obtained by the estimation is increased, and the need to perform the estimation process again due to erroneous estimation is reduced, according to which the process efficiency is improved.

According to the present embodiment, for better understanding and the like, the media having different “distances from the disk surface to the recording layer” are largely divided into two types, the CD-based type and the DVD-based type, and the media having different “disk reflectivities” are largely divided into two types, the pit-type media and the phase change-type media. However, the present invention is not restricted to the above embodiment, and there may be multiple (more than two) types of media having different “distances from the disk surface to the recording layer” and multiple types of media having different “disk reflectivities”. By considering the relationship between two types of media out of the multiple types of media, the concept of the present embodiment described above can be applied to the multiple media types, and thus the present invention can be effectively applied to such example.

### Embodiment 2

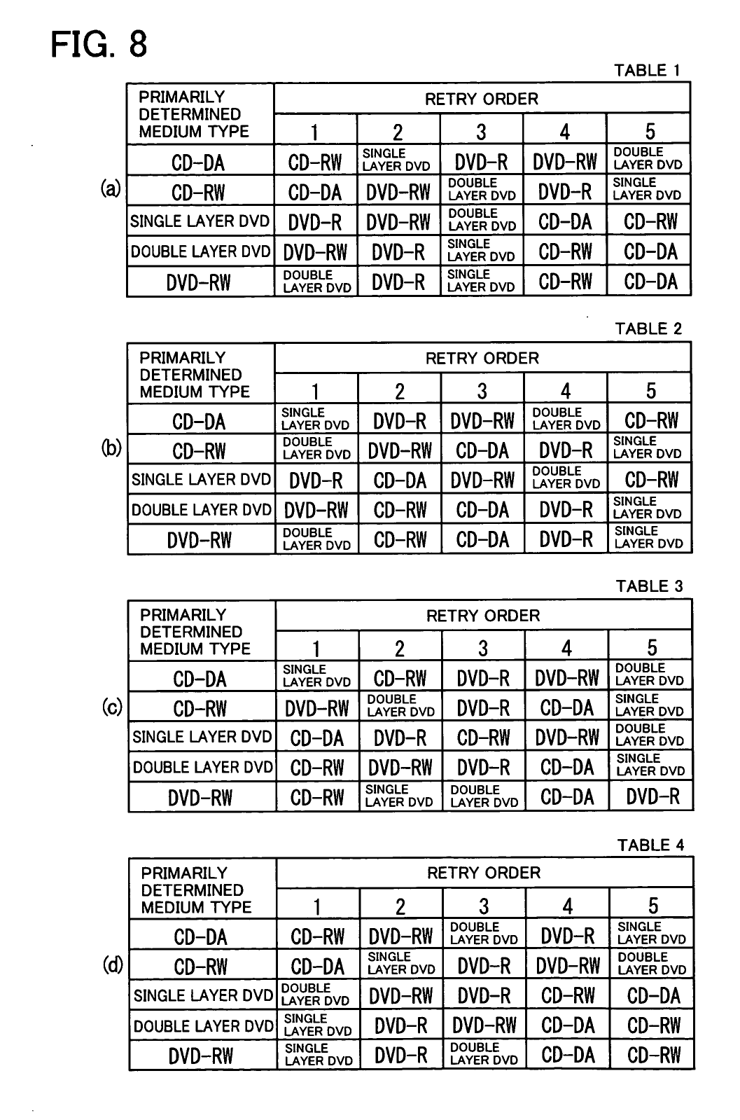

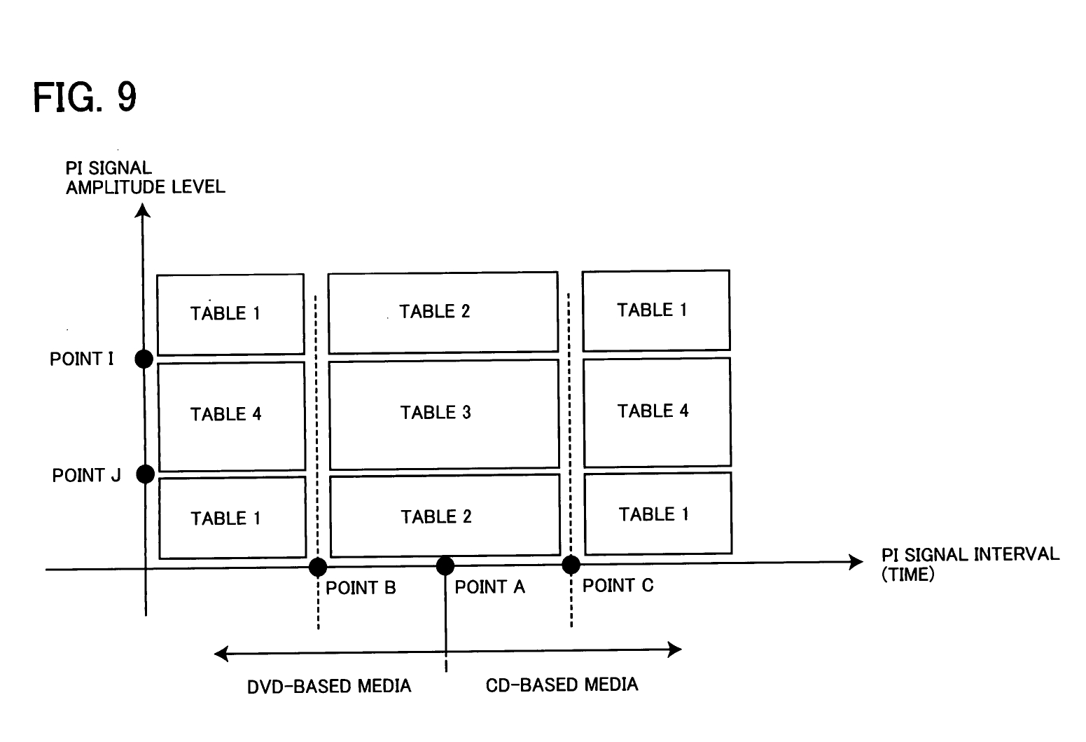

FIG. 8 shows tables stored in the optical disk medium recording and reproducing apparatus according to the present embodiment, and FIG. 9 is a concept view showing the relationship between the method for discriminating the optical disk medium type according to the optical disk medium recording and reproducing apparatus of the present embodiment and the tables used for estimating the medium type when the discrimination is erroneous. Incidentally, the structure of the optical disk medium recording and reproducing apparatus according to the present embodiment is equivalent to that of embodiment 1, so the detailed descriptions thereof are omitted, and FIG. 1 is referred to if necessary for description.

The optical disk medium recording and reproducing apparatus according to the present embodiment is capable of reproducing or recording data on CD-DA and CD-RW of the CD-based media and reproducing or recording data on DVD-ROM (hereinafter called single layer DVD), DVD-R, DVD-RW and DVD-ROM having two recording layers (hereinafter called double layer DVD) of the DVD-based media.

FIG. 8 shows tables storing the order of estimation of medium types in case the discrimination of the optical disk medium type fails, wherein the tables are used according to conditions shown in FIG. 9. As illustrated in FIG. 8, similar to embodiment 1, the present embodiment includes “point A” functioning as a threshold for primarily discriminating the CD-based optical disk media from the DVD-based optical disk media, and “point B” and “point C” which are used as thresholds for re-discriminating (estimating) the medium type when the primary discrimination fails. Furthermore, the present embodiment includes “point I” and “point J” used as thresholds for re-discrimination (estimation). “Point I” and “point J” are thresholds of “reflectivity”, determined so as to sandwich “point D” used as the threshold for primarily discriminating whether the medium is a pit-type medium or a phase change-type medium.

In the estimation of the optical disk medium type in case the primary optical disk medium discrimination fails, if the “distance from the disk surface to the recording layer” obtained in the primary discrimination falls between “point B” and “point C”, “table 3 (FIG. 8(c))” is used if the reflectivity obtained in the primary discrimination falls between “point I” and “point J”, and “table 2 (FIG. 8(b))” is used when it des not fall between “point I” and “point J”. If the distance from the disk surface to the recording layer obtained in the primary discrimination does not fall between “point B” and “point C”, “table 4 (FIG. 8(d))” is used when the reflectivity falls between “point I” and “point J”, and “table 1 (FIG. 8(a))” is used when it does not fall between “point I” and “point J” in estimating the optical disk medium type. Similar to embodiment 1, the storage unit 17 of the optical disk medium recording and reproducing apparatus stores information denoting “point A”, “point B”, “point C” and “point D” in variables “a”, “b”, “c” and “d”, and information denoting “point I” and “point J” in variables “i” and “j”.

As can be seen from FIG. 9, table 1 is a table used when the reliability of both the discrimination of the disk medium type based on the information on the “distance from the disk surface to the recording layer” and the discrimination of the disk medium type based on the information on the “reflectivity” are high, and the retry order is determined using the distance information as the primary factor and the reflectivity information as the secondary factor. For example, when the medium is discriminated as a DVD-based medium, the retry order of DVD-based media are set higher, and if based on the primary discrimination the reflectivity is determined to be high, the retry order of the DVD media is set in the order of reflectivity starting from the media having the highest reflectivity. On the other hand, table 4 is a table used when the reliability of the discrimination of the disk medium type based on the information on the “distance from the disk surface to the recording layer” is high but the reliability on the discrimination of the disk medium type based on the information on the “reflectivity” is relatively low, which is formed using the distance information as the primary factor and the reflectivity information as the secondary factor similarly as table 1, but the order based on the reflectivity information is reversed. For example, if the reflectivity is determined to be high in the primary discrimination, the retry order is determined so that the medium having the lowest reflectivity is set to have the highest retry order. Furthermore, it is possible to utilize the “frequency of use” or the “order used nearest” of the disk medium as the secondary factor for determining the retry order.

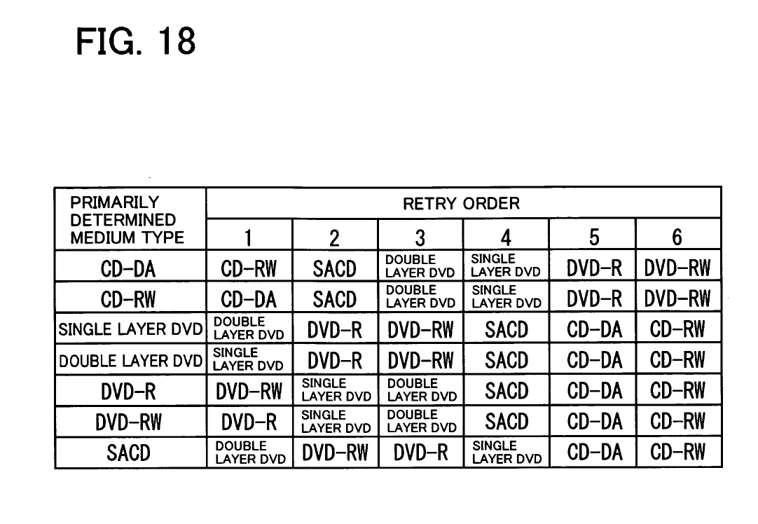

Table 2 is a table used when the reliability of the discrimination of the disk medium type based on the information on the “distance from the disk surface to the recording layer” is relatively low, but the reliability of the discrimination of the disk medium type based on the information on the “reflectivity” is high. Accordingly, in table 2, the retry order is determined so that the medium having the closest reflectivity to the primarily determined “reflectivity” is set highest. In other words, table 2 is a table having the retry order determined based on the reflectivity information. Table 3 is a table used when both the reliability of the discrimination of the disk medium type based on the information on the “distance from the disk surface to the recording layer” and the discrimination of the disk medium type based on the information on the “reflectivity” are both low, and according to the present embodiment, the CD system media and DVD system media are retried alternately. The retry order according to the present table 3 can be similar to the prior art (for example, FIG. 18), or can be determined based on the “frequency of use” of each disk medium, or can be determined based on the “order used nearest”. This is because since table 3 is used when both the “distance information” and the “reflectivity information” have low reliability, there is little meaning in determining the retry order based on the “distance information” or the “reflectivity information”.

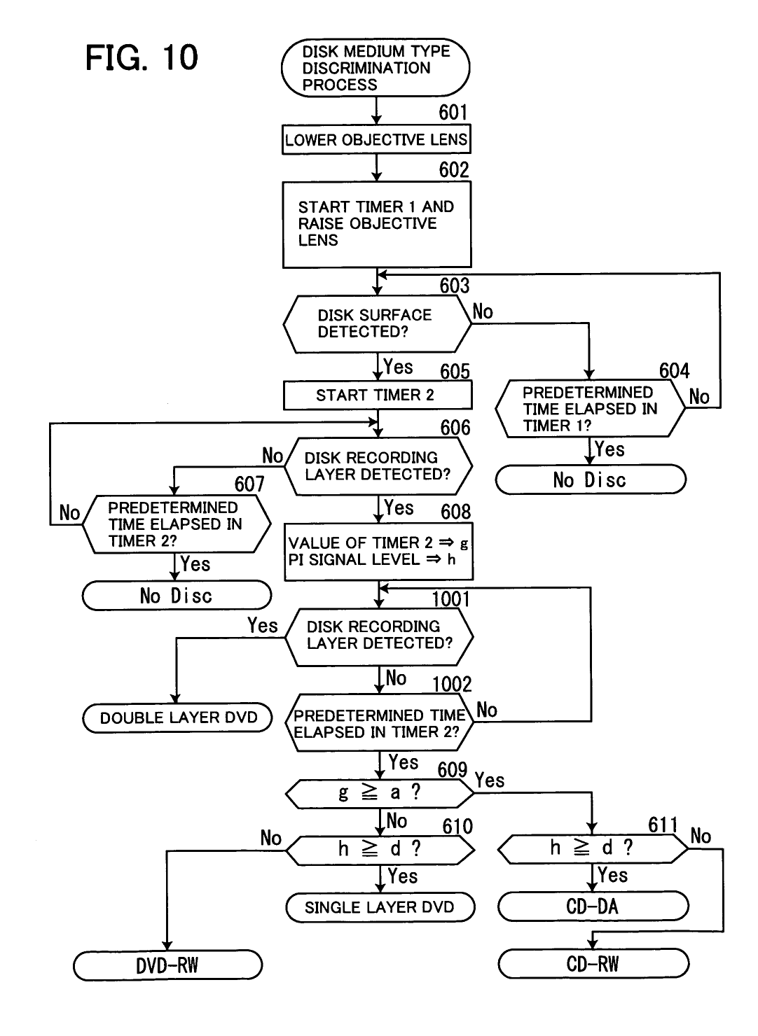

According to the optical disk medium recording and reproducing apparatus arranged as above, the outline of the determination and estimation process of the optical disk medium type 2 will now be described with reference to FIGS. 10, 11 and 12. As for processes based on the concept similar to embodiment 1 (FIGS. 6 and 7), the same reference numbers are used and the detailed descriptions thereof are omitted or simplified.

The disk medium type discrimination process of FIG. 10 is a process with a concept similar to that of embodiment 1 (FIG. 6), but whether a recording layer is detected again or not is determined in step 1001 subsequent to step 608, after detecting the recording layer in step 606. Accordingly, if the recording layer is detected again, it means that there are two recording layers, so the medium is discriminated as the “double layer DVD”. In step 1002, the passing of a predetermined time set in advance in the storage unit 17 is determined, and if the time has passed, it is determined that there is no second recording layer, and the process advances to step 609 where the process similar to embodiment 1 is performed. Further, as can be seen from the present process, the primary disk medium type discrimination process cannot discriminate all the optical disk medium types usable in the optical disk medium recording and reproducing apparatus of the present embodiment, and therefore, some types of media are not included in the “primarily determined medium type” in the table illustrated in FIG. 8, and the types not discriminated are coped with in the following disk medium type estimation process.

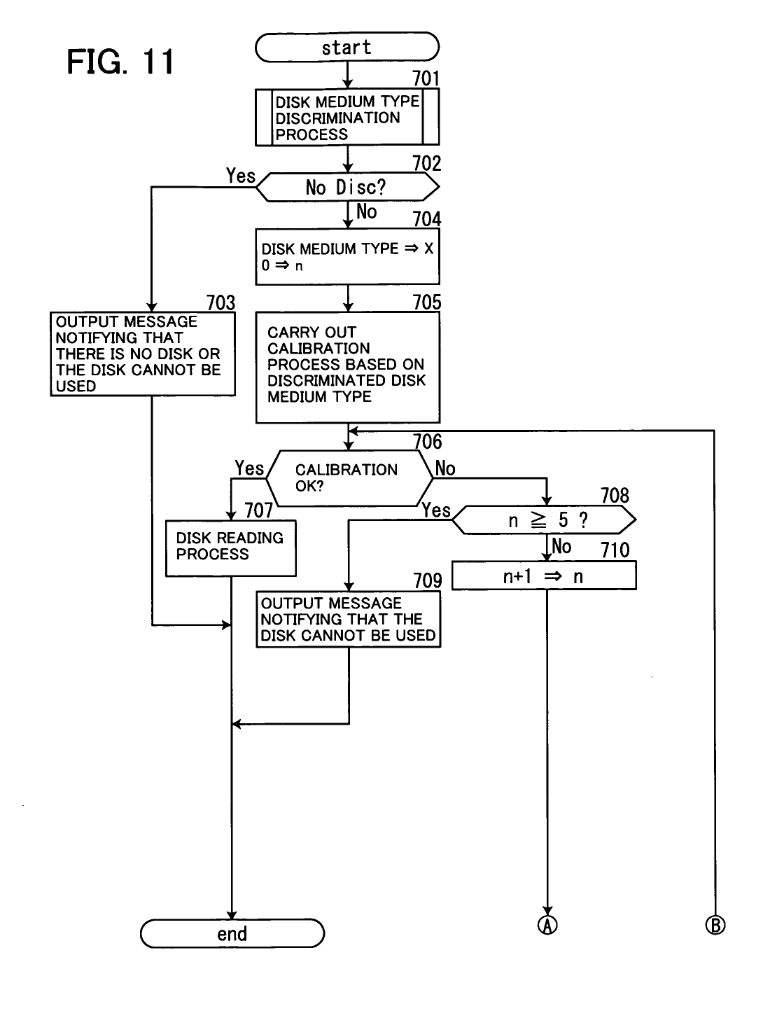

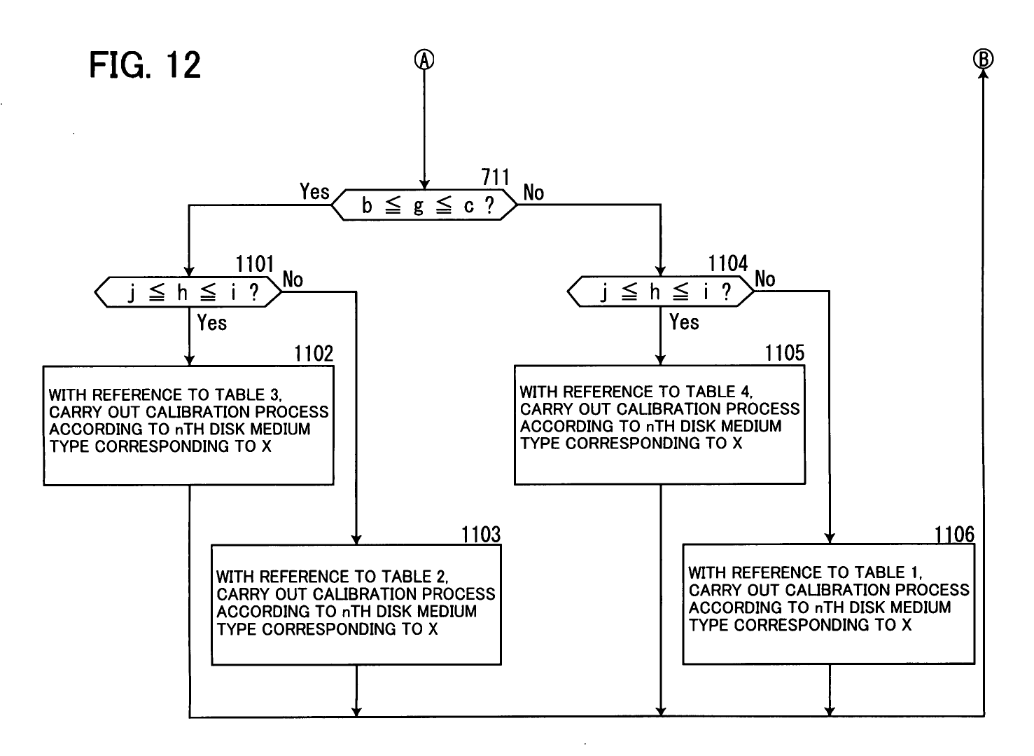

The process illustrated in FIGS. 11 and 12 is based on a similar process concept as that of embodiment 1 (FIG. 7), but in steps 1101 through 1106 (FIG. 12) subsequent to step 711, the tables (FIG. 8) are selected based on the conditions shown in FIG. 9, and based on the selected table, the estimation of the optical disk medium type is performed, and the calibration process is performed using the parameters according to the estimated medium type. Further, in step 708 (FIG. 11), the number of times of re-estimations is changed to five. This is because there are six media types, and the “estimation” is performed for five times at maximum.

As described, according to the optical disk medium recording and reproducing apparatus of the present embodiment, thresholds related to “reflectivity” are provided in addition to thresholds used for re-discrimination (estimation) in case the primary discrimination fails, according to which more detailed settings for operation can be determined in the process for estimating the medium type.

### Embodiment 3

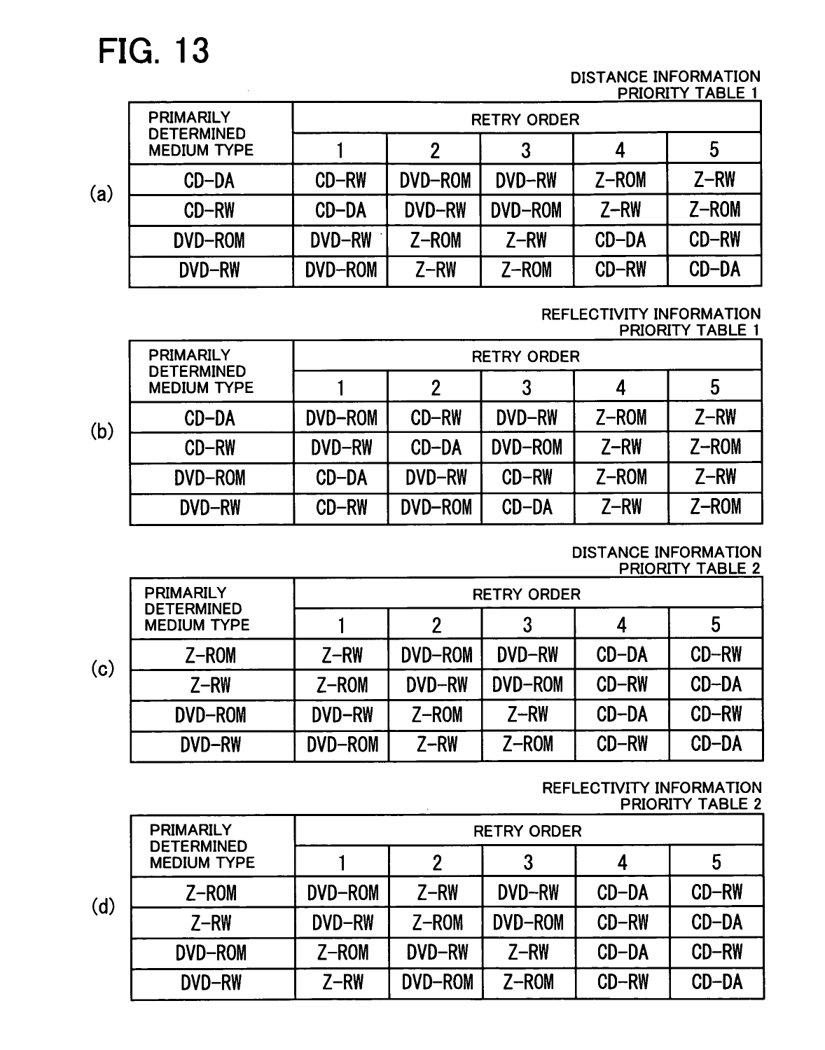

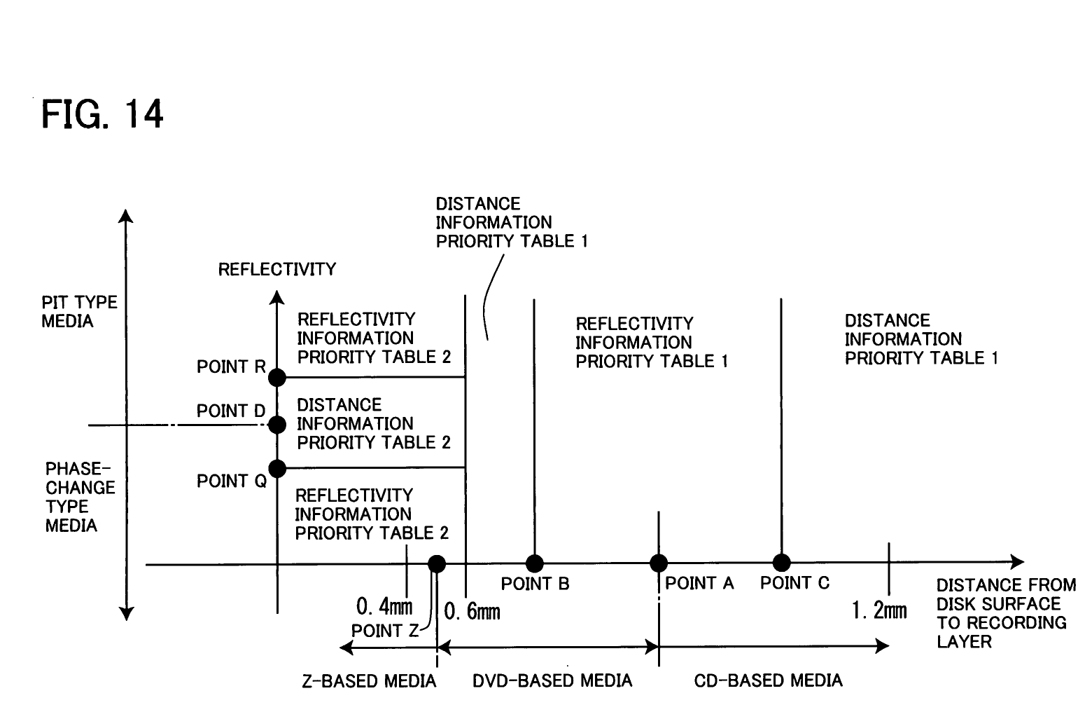

FIG. 13 shows tables stored in the optical disk medium recording and reproducing apparatus according to the present embodiment, and FIG. 14 is a concept view showing the relationship between the method for discriminating the optical disk medium type according to the optical disk medium recording and reproducing apparatus of the present embodiment and the tables used for estimating the medium type when the discrimination fails. Since the structure of the optical disk medium recording and reproducing apparatus according to the present embodiment is equivalent to that of embodiment 1, the detailed descriptions thereof are omitted, and FIG. 1 is referred to if necessary for description.

The optical disk medium recording and reproducing apparatus according to the present embodiment is capable of reproducing or recording data on CD-based media and DVD-based media similar to embodiment 1, and in addition, capable of reproducing or recording data on a “Z-based” media having a “distance from the disk surface to the recording layer” that is smaller than the DVD-based media (approximately 0.6 mm) (for example, approximately 0.4 mm), and the recording layer of which is further categorized into a “pit-type” layer and a “phase change-type” layer, similar to the CD-based media and the DVD-based media. Note that the “Z-based” media do not actually exist, and they are used merely for describing the concept of the present invention.

FIG. 13 shows tables storing the order of estimation of the media types when the primary discrimination of the optical disk medium type fails, and the tables are used according to the conditions shown in FIG. 14. The relationship between the CD-based media and DVD-based media is basically equivalent to that of embodiment 1, wherein the reflectivity information priority table 1 (FIG. 13(b)) has Z-based media added to numbers 4 and 5 of the retry order with respect to the reflectivity information priority table 32 (FIG. 3(b)) of embodiment 1. The orders of the Z-based media are determined based on the reflectivity information. As for the distance information priority table 1 (FIG. 13(a)), the table also has the Z-based media added to the distance information priority table 31 (FIG. 3(a)) of embodiment 1, wherein if the “primarily determined medium type” is a DVD-based media, the Z-based media is prioritized over the CD-based media, since the differences in the distance from the disk surface to the recording layer are smaller between the DVD-based media and the Z-based media than between the DVD-based media and the CD-based media, and therefore, erroneous discrimination is more likely to occur between the DVD-based media and the Z-based media than between the DVD-based media and the CD-based media.

Since the difference between the “distances from the disk surface to the recording layer” of the DVD-based media and Z-based media is small, which is respectively approximately 0.6 mm and 0.4 mm, the reliability of the discrimination performed based on the “distance from the disk surface to the recording layer” is relatively low, so when it is determined that the reliability of the reflectivity information is high, the “reflectivity” information is prioritized in determining the “retry order”. Actually, the reflectivity information priority table 2 (FIG. 13(d)) is composed using the reflectivity information as the primary factor and the distance information as the secondary factor, whereas the distance information priority table 2 (FIG. 13(c)) is composed using the distance information as the primary factor and the reflectivity information as the secondary factor. Further, as can be seen in FIG. 14, under the condition in which both the tables are to be used, that is, when it is determined that the “distance from the disk surface to the recording layer” is 0.6 mm or smaller, the possibility that a CD-based medium has been erroneously detected is small, so the retry orders of CD-based media appear last in both tables. In addition, by setting “point R” and “point Q” that are offset for predetermined distances from “point D” which is the threshold related to the reflectivity for discriminating the “pit-type media” and the “phase change-type media”, the “range in which the reliability of the reflectivity information is determined to be low (or in the opposite view, the range in which the reliability is high)” is determined, and when the reflectivity information obtained in the primary distinction of optical dick medium type corresponds to the “range in which the reliability is high”, the retry order is determined using the reflectivity information priority table 2 (FIG. 13(d)), whereas if the reflectivity information corresponds to the “range in which the reliability is low”, retry is performed prioritizing the distance information using the distance information priority table 2 (FIG. 13(c)). Further, “point R” and “point Q” are set to fall between the reflectivity of a “pit-type” medium (first reflectivity) and the reflectivity of a “phase change-type” medium (second reflectivity).

In the “primarily determined medium type” of each of the tables of FIG. 13, the media that do not fall under the condition in which each table is used are eliminated. For example, under the condition in which the reflectivity information priority table 1 (FIG. 13(b)) is used, wherein the distance information falls between point B and point C in the primary discrimination, the medium could not possibly be discriminated as a Z-based medium, so the Z-based media are eliminated therefrom. Further, similar to embodiment 1, in the storage unit 17 of the optical disk medium recording and reproducing apparatus, the information denoting “point A”, “point B”, “point C” and “point D” are stored in variables “a”, “b”, “c” and “d”, respectively, and in addition, the information denoting “point R”, “point Q” and “point Z” are stored in variables “r”, “q” and “z”, and the information denoting the distance information of “0.6 mm” is stored in variable “v”.

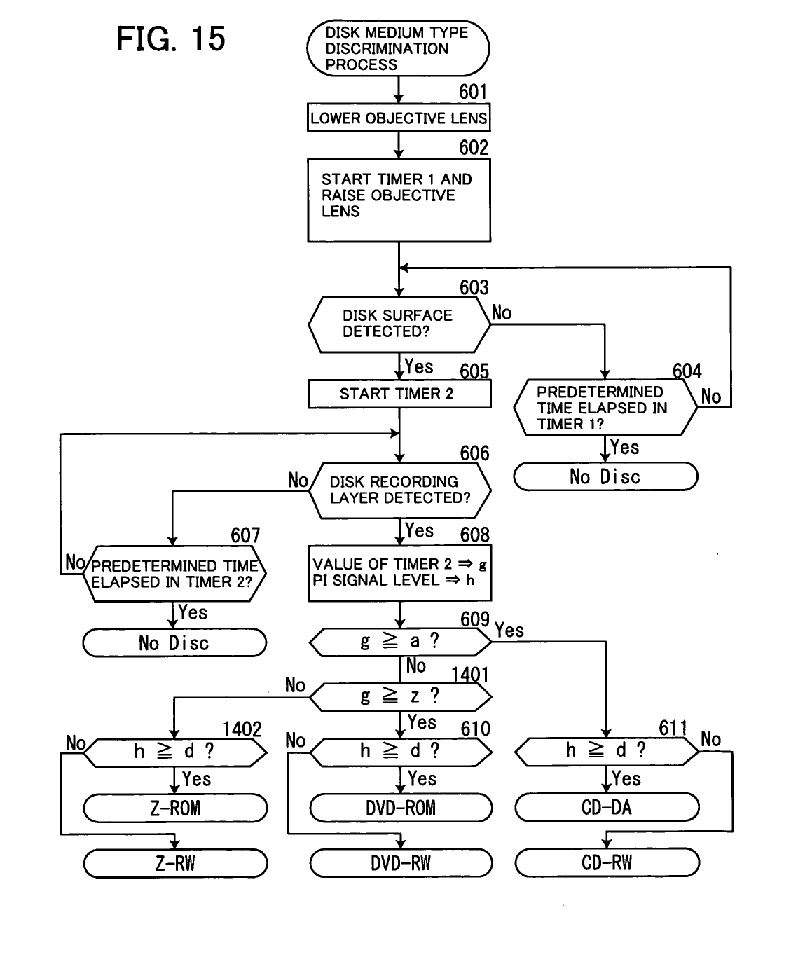

The outline of the discrimination and estimation processes of the type of optical disk medium 2 according to the optical disk medium recording and reproducing apparatus having the arrangement described above will be described with reference to FIGS. 15, 16 and 17. As for processes based on the concept similar to embodiment 1 (FIGS. 6 and 7), the same reference numbers are used and the detailed descriptions thereof are omitted or simplified.

The disk medium type discrimination process of FIG. 15 is basically based on a processing concept similar to that of embodiment 1 (FIG. 6), but in step 1401 subsequent to step 609, whether g is greater than z or not, in other words, whether the medium is categorized to the right side (DVD-based media) of “point Z” or the left side (Z-based media) thereof, is distinguished, and when g is determined to be smaller than z, that is, when the medium is determined to be the Z-based media, the procedure advances to step 1402 where it is determined whether the medium is a “Z-RW” or a “Z-ROM”.

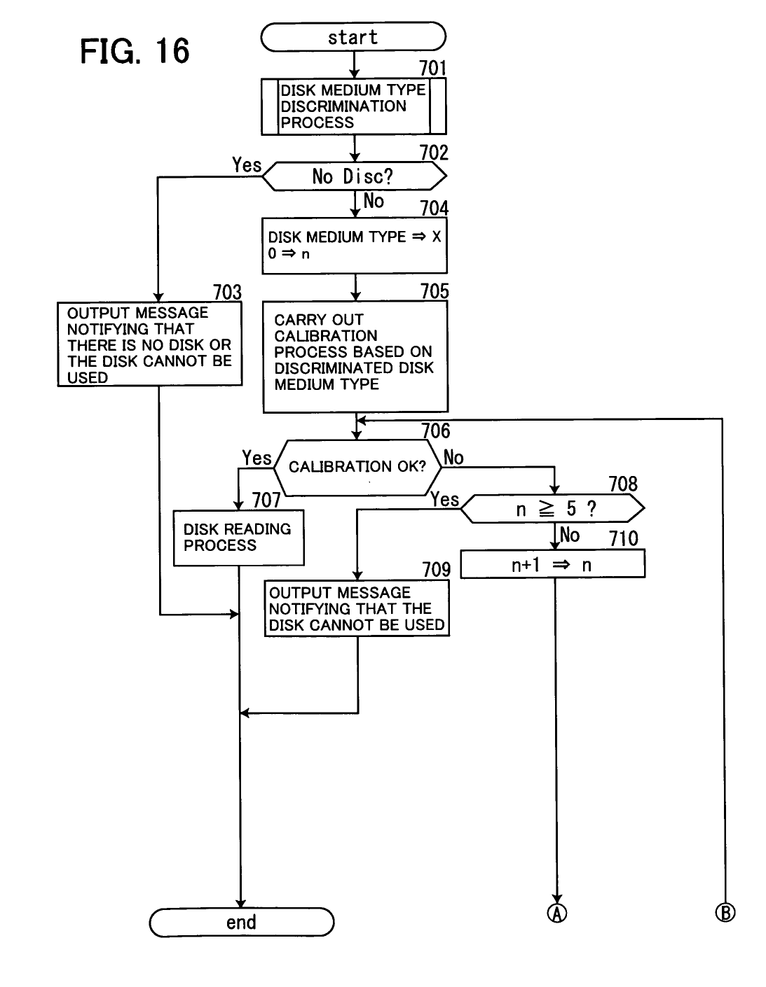

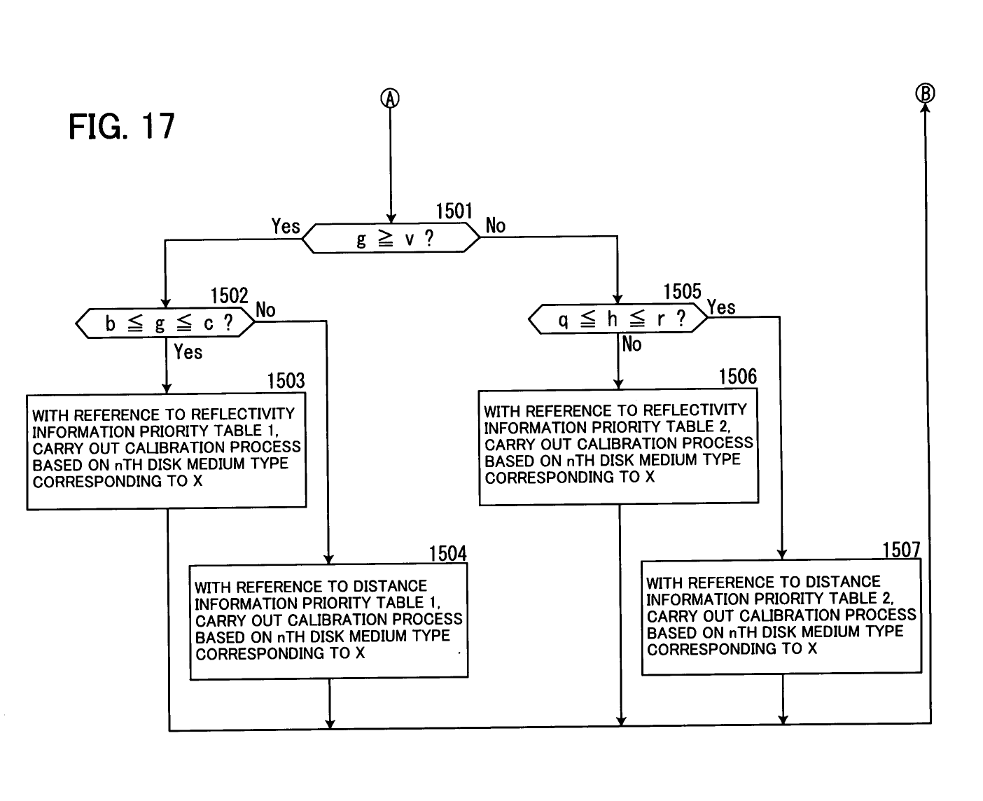

The process illustrated in FIGS. 16 and 17 is basically based on a processing concept similar to that of embodiment 1 (FIG. 7), but in steps 1501 through 1507 subsequent to step 710 (FIG. 17), the selection of each table (FIG. 13) is performed to comply with the conditions shown in FIG. 14, and the estimation of the optical disk medium type is performed based on the selected table to carry out the calibration process using the parameters corresponding to the estimated medium type. Moreover, in step 708 (FIG. 16), the number of times of re-estimation is changed to five. This is because there are six media types, and the estimation thereof is performed for five times at maximum.

As described, according to the optical disk medium recording and reproducing apparatus of the present embodiment, it becomes possible to change the conditions of the medium type estimation process based on the properties of the relationship among the various media types. For example, according to the present embodiment, the priority of the recording layer distance information can be lowered according to the properties of the relationship between the Z-based media and the DVD-based media, which have similar distances to recording layers. Accordingly, the present embodiment enables to perform the disk type estimation process in an efficient manner.

The effects of the present invention are as follows.

Aspect 1 of the present invention provides an optical disk medium recording and reproducing apparatus capable of performing recording or reproducing operation to multiple types of optical disk media having various distances from a disk surface to a recording layer and various reflectivities to laser beams, the apparatus comprising: a light source unit for irradiating a laser beam to the optical disk medium; a reflectivity measurement unit for acquiring information on the reflectivity of the optical disk medium with respect to the laser beam output from the light source unit; a recording layer depth measurement unit for acquiring information on the distance from the disk surface to the recording layer; and a storage unit for storing a predetermined range between a first distance and a second distance, one of two types of optical disk media selected from the multiple types of optical disk media having the first distance from the disk surface to the recording layer and the other one having the second distance from the disk surface to the recording layer; wherein after discriminating the optical disk medium type based on the distance information from the disk surface to the recording layer acquired by the recording layer depth measurement unit and the reflectivity information of the optical disk medium acquired by the reflectivity measurement unit, if it is determined that the discrimination of the optical disk medium type has failed and if the distance information from the disk surface to the recording layer acquired by the recording layer depth measurement unit corresponds to the predetermined range, the information of the reflectivity acquired by the reflectivity measurement unit is prioritized in estimating the optical disk medium type, whereas if it is determined that the discrimination of the optical disk medium type has failed and if the distance information from the disk surface to the recording layer acquired by the recording layer depth measurement unit does not correspond to the predetermined range, the distance information from the disk surface to the recording layer is prioritized in estimating the optical disk medium type. According to this aspect of the present invention, if the reliability of the distinction on whether the distance from the disk surface to the recording layer is a “first distance” or a “second distance” is low, that is, if erroneous discrimination is likely to occur, the “reflectivity information of the disk” is prioritized over the “distance information from the disk surface to the recording layer” in estimating the optical disk medium type, and on the other hand, if the reliability of the distinction on whether the distance from the disk surface to the recording layer is a “first distance” or a “second distance” is high, that is, if erroneous discrimination is not likely to occur, the “distance information from the disk surface to the recording layer” is prioritized in estimating the optical disk medium type, so the efficiency of the disk type estimation process is promoted. In other words, according to the present invention, if the correct optical disk medium type is not obtained by the primary discrimination of the optical disk medium type, the priority of the “information likely to cause erroneous discrimination” is lowered and the priority of the “information not likely to cause erroneous discrimination” is raised in order to estimate the disk medium type, so the possibility of the correct optical disk medium type being obtained by the estimation is raised and the necessity of a re-estimation process due to erroneous estimation is reduced, by which the process efficiency is promoted.

Aspect 3 of the present invention provides an optical disk medium recording and reproducing apparatus according to aspects 1 or 2, wherein upon estimating the optical disk medium type prioritizing the reflectivity information, the estimation of the optical disk medium type is performed using the distance information from the disk surface to the recording layer acquired by the recording layer depth measurement unit as the secondary determination factor, whereas upon estimating the optical disk medium type prioritizing the information of the distance from the disk surface to the recording layer, the estimation of the optical disk medium type is performed using the reflectivity information acquired by the reflectivity measurement unit as the secondary determination factor. According to this aspect of the present invention, since the estimation of the optical disk medium type is performed by determining in advance the priority of the information and using both the “distance information from the disk surface to the recording layer” and the “reflectivity information of the disk” in performing estimation of the optical disk medium type, the possibility of achieving the correct optical disk medium type by the estimation is increased further, and the efficiency of the estimation process of the disk type is further promoted.

1. An optical disk medium recording and reproducing apparatus capable of performing recording or reproducing operation to multiple types of optical disk media having various distances from a disk surface to a recording layer and various reflectivities to laser beam, the apparatus comprising:
a light source unit for irradiating a laser beam to the optical disk medium;
a reflectivity measurement unit for acquiring information on the reflectivity of the optical disk medium with respect to the laser beam output from the light source unit;
a recording layer depth measurement unit for acquiring information on the distance from the disk surface to the recording layer; and
a storage unit for storing a predetermined range between a first distance and a second distance, one of two types of optical disk media selected from the multiple types of optical disk media having the first distance from the disk surface to the recording layer and the other one having the second distance from the disk surface to the recording layer; wherein
after discriminating the optical disk medium type based on the distance information from the disk surface to the recording layer acquired by the recording layer depth measurement unit and the reflectivity information of the optical disk medium acquired by the reflectivity measurement unit, if it is determined that the discrimination of the optical disk medium type has failed and if the distance information from the disk surface to the recording layer acquired by the recording layer depth measurement unit corresponds to the predetermined range, the information of the reflectivity acquired by the reflectivity measurement unit is prioritized in estimating the optical disk medium type, whereas if it is determined that the discrimination of the optical disk medium type has failed and if the distance information from the disk surface to the recording layer acquired by the recording layer depth measurement unit does not correspond to the predetermined range, the distance information from the disk surface to the recording layer is prioritized in estimating the optical disk medium type.

2. An optical disk medium recording and reproducing apparatus capable of performing recording or reproducing operation to multiple types of optical disk media having various distances from a disk surface to a recording layer and various reflectivities to laser beam, the apparatus comprising:
a light source unit for irradiating a laser beam to the optical disk medium;
a reflectivity measurement unit for acquiring information on the reflectivity of the optical disk medium with respect to the laser beam output from the light source unit;
a recording layer depth measurement unit for acquiring information on the distance from the disk surface to the recording layer; and
a storage unit for storing a predetermined range between a first reflectivity and a second reflectivity, one of two types of optical disk media selected from the multiple types of optical disk media having the first reflectivity to the laser beam and the other one having the second reflectivity to the laser beam; wherein
after discriminating the optical disk medium type based on the distance information from the disk surface to the recording layer acquired by the recording layer depth measurement unit and the reflectivity information of the optical disk medium acquired by the reflectivity measurement unit, if it is determined that the discrimination of the optical disk medium type has failed, wherein if the reflectivity information of the optical disk medium acquired by the reflectivity measurement unit corresponds to the predetermined range, the distance information from the disk surface to the recording layer acquired by the recording layer depth measurement unit is prioritized in estimating the optical disk medium type, whereas if the reflectivity information of the optical disk medium acquired by the reflectivity measurement unit does not correspond to the predetermined range, the reflectivity information is prioritized in estimating the optical disk medium type.

3. The optical disk medium recording and reproducing apparatus according to claim 1, wherein upon estimating the optical disk medium type prioritizing the reflectivity information, the estimation of the optical disk medium type is performed using the distance information from the disk surface to the recording layer acquired by the recording layer depth measurement unit as the secondary determination factor, whereas upon estimating the optical disk medium type prioritizing the information of the distance from the disk surface to the recording layer, the estimation of the optical disk medium type is performed using the reflectivity information acquired by the reflectivity measurement unit as the secondary determination factor.

4. The optical disk medium recording and reproducing apparatus according to claim 1, wherein upon performing a calibration process which is a correction process of various parameters corresponding to the optical disk medium type discriminated or estimated based on the discrimination process or the estimation process of the optical disk medium type, if the calibration process fails, the apparatus determines that the discrimination or estimation of the optical disk medium type has failed, and if it is determined that the discrimination or estimation has failed, the estimation or re-estimation of the optical disk medium type is performed, and based on the optical disk medium type estimated thereby, a retry of the calibration process is performed based on the estimated optical disk medium type.

5. The optical disk medium recording and reproducing apparatus according to claim 4, wherein the storage unit stores tables storing information on the order of optical disk medium types for performing retry of the calibration process when the primary discrimination has failed for each type of optical disk medium determined primarily by the discrimination process, the tables including a distance information priority table using the distance information from the disk surface to the recording layer corresponding to the primarily determined optical disk medium type as the primary factor and the reflectivity information thereof as the secondary factor upon applying order information to the optical disk medium type, and a reflectivity information priority table using the reflectivity information corresponding to the primarily determined optical disk medium type as the primary factor and the distance information from the disk surface to the recording layer thereof as the secondary factor upon applying order information to the optical disk medium type; wherein
upon performing retry of the calibration process, if the distance information from the disk surface to the recording layer is prioritized in estimating the optical disk medium type, the estimation is performed by referring to the distance information priority table, whereas if the reflectivity information is prioritized in estimating the optical disk medium type, the estimation is performed by referring to the reflectivity information priority table.

6. A method for discriminating optical disk medium type of an optical disk medium recording and reproducing apparatus capable of performing recording or reproducing operation to multiple types of optical disk media having various distances from a disk surface to a recording layer and various reflectivities to laser beam, the method comprising:
determining in advance a predetermined range between a first distance and a second distance, one of two types of optical disk media selected from the multiple types of optical disk media having the first distance from the disk surface to the recording layer and the other one having the second distance from the disk surface to the recording layer; wherein
after discriminating the optical disk medium type based on the distance information from the disk surface to the recording layer and the reflectivity information of the optical disk medium, if it is determined that the discrimination of the optical disk medium type has failed and if the distance information from the disk surface to the recording layer corresponds to the predetermined range, the reflectivity information is prioritized in estimating the optical disk medium type, whereas if it is determined that the discrimination of the optical disk medium type has failed and if the distance information from the disk surface to the recording layer does not correspond to the predetermined range, the distance information from the disk surface to the recording layer is prioritized in estimating the optical disk medium type.

7. A method for discriminating optical disk medium type of an optical disk medium recording and reproducing apparatus capable of performing recording or reproducing operation to multiple types of optical disk media having various distances from a disk surface to a recording layer and various reflectivities to laser beam, the method comprising:
determining in advance a predetermined range between a first reflectivity and a second reflectivity, one of two types of optical disk media selected from the multiple types of optical disk media having the first reflectivity and the other one having the second reflectivity; wherein
after discriminating the optical disk medium type based on the distance information from the disk surface to the recording layer and the reflectivity information of the optical disk medium, if it is determined that the discrimination of the optical disk medium type has failed, wherein if the reflectivity information of the optical disk medium corresponds to the predetermined range, the distance information from the disk surface to the recording layer is prioritized in estimating the optical disk medium type, whereas if the reflectivity information of the optical disk medium does not correspond to the predetermined range, the reflectivity information is prioritized in estimating the optical disk medium type.

8. The optical disk medium recording and reproducing apparatus according to claim 2, wherein upon estimating the optical disk medium type prioritizing the reflectivity information, the estimation of the optical disk medium type is performed using the distance information from the disk surface to the recording layer acquired by the recording layer depth measurement unit as the secondary determination factor, whereas upon estimating the optical disk medium type prioritizing the information of the distance from the disk surface to the recording layer, the estimation of the optical disk medium type is performed using the reflectivity information acquired by the reflectivity measurement unit as the secondary determination factor.

9. The optical disk medium recording and reproducing apparatus according to claim 2, wherein upon performing a calibration process which is a correction process of various parameters corresponding to the optical disk medium type discriminated or estimated based on the discrimination process or the estimation process of the optical disk medium type, if the calibration process fails, the apparatus determines that the discrimination or estimation of the optical disk medium type has failed, and if it is determined that the discrimination or estimation has failed, the estimation or re-estimation of the optical disk medium type is performed, and based on the optical disk medium type estimated thereby, a retry of the calibration process is performed based on the estimated optical disk medium type.

10. The optical disk medium recording and reproducing apparatus according to claim 3, wherein upon performing a calibration process which is a correction process of various parameters corresponding to the optical disk medium type discriminated or estimated based on the discrimination process or the estimation process of the optical disk medium type, if the calibration process fails, the apparatus determines that the discrimination or estimation of the optical disk medium type has failed, and if it is determined that the discrimination or estimation has failed, the estimation or re-estimation of the optical disk medium type is performed, and based on the optical disk medium type estimated thereby, a retry of the calibration process is performed based on the estimated optical disk medium type.

11. The optical disk medium recording and reproducing apparatus according to claim 8, wherein upon performing a calibration process which is a correction process of various parameters corresponding to the optical disk medium type discriminated or estimated based on the discrimination process or the estimation process of the optical disk medium type, if the calibration process fails, the apparatus determines that the discrimination or estimation of the optical disk medium type has failed, and if it is determined that the discrimination or estimation has failed, the estimation or re-estimation of the optical disk medium type is performed, and based on the optical disk medium type estimated thereby, a retry of the calibration process is performed based on the estimated optical disk medium type.

12. The optical disk medium recording and reproducing apparatus according to claim 9, wherein the storage unit stores tables storing information on the order of optical disk medium types for performing retry of the calibration process when the primary discrimination has failed for each type of optical disk medium determined primarily by the discrimination process, the tables including a distance information priority table using the distance information from the disk surface to the recording layer corresponding to the primarily determined optical disk medium type as the primary factor and the reflectivity information thereof as the secondary factor upon applying order information to the optical disk medium type, and a reflectivity information priority table using the reflectivity information corresponding to the primarily determined optical disk medium type as the primary factor and the distance information from the disk surface to the recording layer thereof as the secondary factor upon applying order information to the optical disk medium type; wherein
upon performing retry of the calibration process, if the distance information from the disk surface to the recording layer is prioritized in estimating the optical disk medium type, the estimation is performed by referring to the distance information priority table, whereas if the reflectivity information is prioritized in estimating the optical disk medium type, the estimation is performed by referring to the reflectivity information priority table.

13. The optical disk medium recording and reproducing apparatus according to claim 10, wherein the storage unit stores tables storing information on the order of optical disk medium types for performing retry of the calibration process when the primary discrimination has failed for each type of optical disk medium determined primarily by the discrimination process, the tables including a distance information priority table using the distance information from the disk surface to the recording layer corresponding to the primarily determined optical disk medium type as the primary factor and the reflectivity information thereof as the secondary factor upon applying order information to the optical disk medium type, and a reflectivity information priority table using the reflectivity information corresponding to the primarily determined optical disk medium type as the primary factor and the distance information from the disk surface to the recording layer thereof as the secondary factor upon applying order information to the optical disk medium type; wherein
upon performing retry of the calibration process, if the distance information from the disk surface to the recording layer is prioritized in estimating the optical disk medium type, the estimation is performed by referring to the distance information priority table, whereas if the reflectivity information is prioritized in estimating the optical disk medium type, the estimation is performed by referring to the reflectivity information priority table.

14. The optical disk medium recording and reproducing apparatus according to claim 1, wherein the storage unit stores tables storing information on the order of optical disk medium types for performing retry of the calibration process when the primary discrimination has failed for each type of optical disk medium determined primarily by the discrimination process, the tables including a distance information priority table using the distance information from the disk surface to the recording layer corresponding to the primarily determined optical disk medium type as the primary factor and the reflectivity information thereof as the secondary factor upon applying order information to the optical disk medium type, and a reflectivity information priority table using the reflectivity information corresponding to the primarily determined optical disk medium type as the primary factor and the distance information from the disk surface to the recording layer thereof as the secondary factor upon applying order information to the optical disk medium type; wherein
upon performing retry of the calibration process, if the distance information from the disk surface to the recording layer is prioritized in estimating the optical disk medium type, the estimation is performed by referring to the distance information priority table, whereas if the reflectivity information is prioritized in estimating the optical disk medium type, the estimation is performed by referring to the reflectivity information priority table.
